(19) United States
(12) Patent Application Publication
(10) Pub. No.: US 2010/0158520 A1
(43) Pub. Date: Jun. 24, 2010

(54) LAN EMULATION METHOD IN WDM-PON AND INFORMATION STORAGE MEDIUM

(76) Inventors: Kyeong-eun Han, Jeonju-si (KR); Kwang-joon Kim, Daejeon-si (KR)

Correspondence Address: BLAKELY SOKOLOFF TAYLOR & ZAFMAN LLP, 1279 OAKMEAD PARKWAY, SUNNYVALE, CA, 94085-4040, US

(21) Appl. No.: 12/604,357

(22) Filed: Oct. 22, 2009

(30) Foreign Application Priority Data
Dec. 22, 2008 (KR) 10-2008-0131700

(51) Int. Cl. H04J 14/02

(52) U.S. Cl. 398/58; 398/72

(57) ABSTRACT

Provided are a local area network (LAN) emulation method and an information storage medium. The LAN emulation method provides a LAN emulation function in an arrayed-waveguide grating (AWG)-based wavelength division multiplexing (WDM)-passive optical network (PON) using a mode bit and a logical link identifier (LLID).

### CROSS-REFERENCE TO RELATED APPLICATION

This application claims the benefit under 35 U.S.C. §119(a) of Korean Patent Application No. 10-2008-0131700, filed on Dec. 22, 2008, the disclosure of which is incorporated herein in its entirety by reference.

### BACKGROUND

1. Field

The following description relates to optical network technology, and more particularly, to a local area network (LAN) emulation method in a wavelength division multiplexing (WDM)-passive optical network (PON) and an information storage medium.

2. Description of the Related Art

As next-generation optical network technology using a WDM technique, WDM-PONs have overcome poor scalability and security of conventional Ethernet PONs (EPONs) and provide high-capacity and high-quality service.

In such a WDM-PON, data transmission from an optical network unit (ONU) is based on point-to-point (P2P) connection with an optical line terminal (OLT). All frames transmitted from an ONU are only received by an OLT, and ONUs cannot directly transmit and receive frames transmitted by other ONUs. Thus, in order to provide a conventional LAN function of using a shared medium in the WDM-PON, a LAN emulation function reflecting a characteristic of the WDM-PON is required.

### SUMMARY

The following description relates to a local area network (LAN) emulation method in a wavelength division multiplexing (WDM)-passive optical network (PON).

According to an exemplary aspect, there is provided a local area network (LAN) emulation method of an optical line terminal (OLT) for a wavelength division multiplexing (WDM)-passive optical network (PON). The method includes receiving a data frame from an optical network unit (ONU) or an external network; checking a PON tag of the data frame received from the ONU including a mode bit and a logical link identifier (LLID) or a destination address (DA) of the data frame received from the external network, and identifying a transmission type of the received data frame; and generating a new data frame based on the result of the identification operation, and transmitting the new data frame to the ONU or the external network.

According to another exemplary aspect, there is provided a data frame receiving method of an optical network unit (ONU) for a wavelength division multiplexing (WDM)-passive optical network (PON). The method includes checking a mode bit and a logical link identifier (LLID) of the data frame when a new data frame arrives; receiving the new data frame when it is found that the mode bit is 0; and receiving the new data frame when it is found that the mode bit is 1 and a source address (SA) is not a media access control (MAC) address of the ONU.

According to still another exemplary aspect, there is provided a logical link identifier (LLID) assignment method of an optical line terminal (OLT) for a wavelength division multiplexing (WDM)-passive optical network (PON). The method includes broadcasting a discovery message including port information and transmission wavelength information to optical network units (ONUs); receiving a registration request message including the port information, the transmission wavelength information and source address (SA) information of the ONU from an ONU receiving the discovery message; transmitting a registration message assigning a LLID to the ONU according to the received registration request message to the ONU; and receiving a registration response message including the assigned LLID from the ONU receiving the registration message.

According to yet another exemplary aspect, there is provided an information storage medium storing a local area network (LAN) emulation layer data structure of an optical line terminal (OLT) for a wavelength division multiplexing (WDM)-passive optical network (PON). The medium includes a media access control (MAC) layer that is a lower layer receiving a data frame transmitted from an optical network unit (ONU), removing a MAC frame header, transmitting a PON tag and data to a shared LAN emulation layer that is an upper layer, receiving a data frame generated from the shared LAN emulation layer, and transmitting the data frame to the ONU; and the shared LAN emulation layer checking a mode bit and a logical link identifier (LLID) of the data frame received through the MAC layer, and transmitting the data frame generated according to the result of the check operation to the MAC layer.

According to yet another exemplary aspect, there is provided an information storage medium storing a structure of a data frame transmitted between a media access control (MAC) layer of an optical line terminal (OLT) for a wavelength division multiplexing (WDM)-passive optical network (PON) and a local area network (LAN) emulation layer that is an upper layer of the MAC layer. The medium includes a preamble; a destination address (DA) field indicating a DA; a source address (SA) field indicating a SA; a type field indicating a type of the data frame; a PON tag including a mode bit for distinguishing between point-to-point (P2P) and broadcast or multicast, and a logical link identifier (LLID) indicating a logical link between the OLT and an optical network unit (ONU); a data field containing data; and a frame check sequence (FCS) field containing information for detecting an error.

Other objects, features and advantages will be apparent from the following description, the drawings, and the claims.

### BRIEF DESCRIPTION OF THE DRAWINGS

FIG. 1 is a block diagram of a wavelength division multiplexing (WDM)-passive optical network (PON) system according to an exemplary embodiment.

FIG. 2 illustrates a routing process of a remote node (RN) in the WDM-PON of FIG. 1.

FIG. 3 is a block diagram illustrating layers of an optical line terminal (OLT) according to an exemplary embodiment.

FIGS. 4A to 4C illustrate constitutions of data frames according to an exemplary embodiment.

FIG. 5 is a flowchart illustrating a local area network (LAN) emulation method of an OLT according to an exemplary embodiment.

FIG. 6 is a flowchart illustrating a data frame receiving method of an optical network unit (ONU) according to an exemplary embodiment.

FIG. 7 is a signal flow diagram illustrating a process of assigning a logical link identifier (LLID) according to an exemplary embodiment.

FIGS. 8A to 8G illustrate constitutions of control messages of FIG. 7 for assigning a LLID.

Elements, features, and structures are denoted by the same reference numerals throughout the drawings and the detailed description, and the size and proportions of some elements may be exaggerated in the drawings for clarity and convenience.

### DETAILED DESCRIPTION

The detailed description is provided to assist the reader in gaining a comprehensive understanding of the methods, apparatuses and/or systems described herein. Various changes, modifications, and equivalents of the systems, apparatuses, and/or methods described herein will likely suggest themselves to those of ordinary skill in the art. Also, descriptions of well-known functions and constructions are omitted to increase clarity and conciseness.

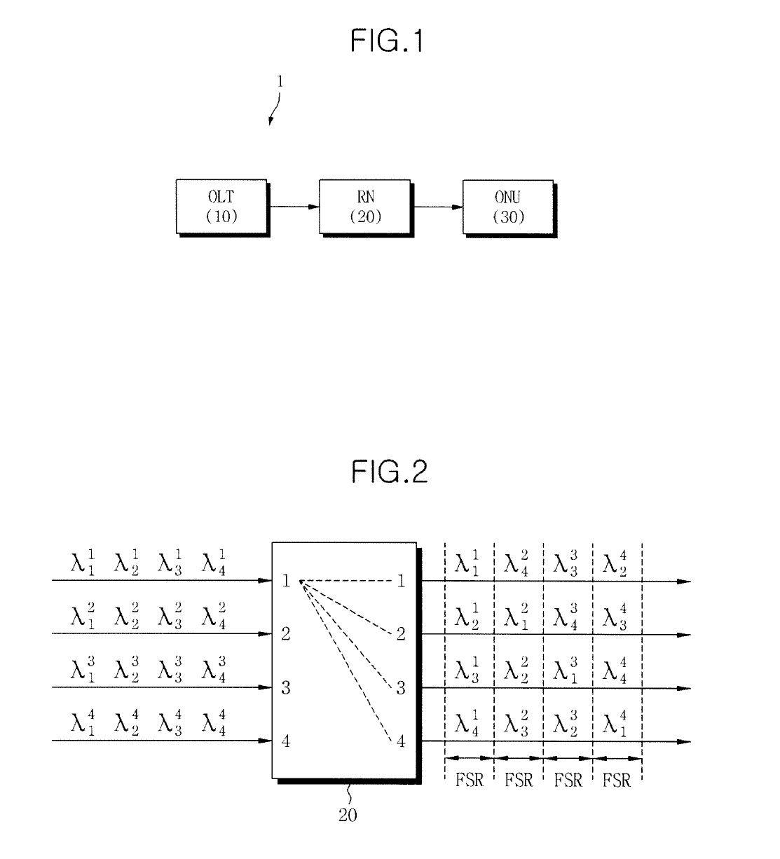

FIG. 1 is a block diagram of a wavelength division multiplexing (WDM)-passive optical network (PON) system 1 according to an exemplary embodiment. Referring to FIG. 1, the PON system 1 according to an exemplary embodiment includes an optical line terminal (OLT) 10, a remote node (RN) 20, and an optical network unit (ONU) 30.

In telecommunication using optical fibers, a WDM technique employed in exemplary embodiments simultaneously transmits a plurality of channels using light of different wavelengths. In a WDM-PON according to an exemplary embodiment, the single OLT 10 and a plurality of the ONUs 30 are connected through the RN 20 in a tree form.

In particular, the RN 20 according to an exemplary embodiment may be configured in the form of an arrayed-waveguide grating (AWG). An AWG is a passive device having a wavelength-selection routing function, and an output port is determined according to a wavelength and an input port. The RN 20 may consist of a single AWG or a plurality of AWGs. Also, the WDM-PON can be connected to a plurality of input ports of an N×N AWG to reuse limited wavelengths. Here, the OLT 10 may transmit data to n of the ONUs 30 using W wavelengths.

FIG. 2 illustrates a routing process of the RN 20 in the WDM-PON of FIG. 1. Referring to FIG. 2, the wavelength-selection routing function of the AWG-based RN 20 is applied, and thus an output port is determined according to an input port of the RN 20 and a wavelength. FIG. 2 illustrates an exemplary embodiment of wavelength-selection routing of the RN 20, and various exemplary embodiments of routing other than this one are also enabled.

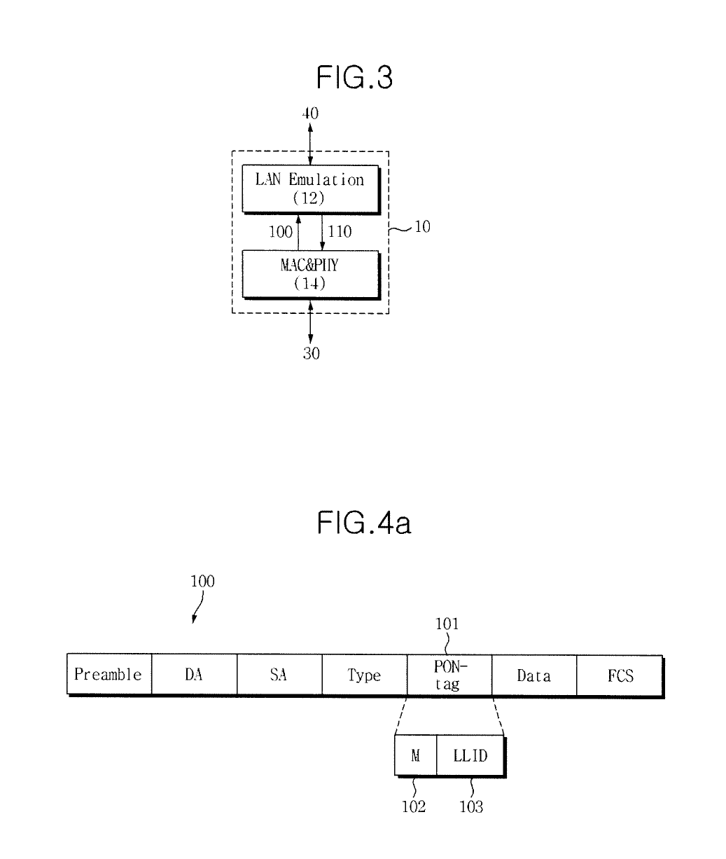

FIG. 3 is a block diagram illustrating layers of the OLT 10 according to an exemplary embodiment. Referring to FIG. 3, LAN emulation according to an exemplary embodiment is performed at a LAN emulation layer 12, which is an upper layer of a media access control (MAC) layer 14, in an AWG-based WDM-PON. LAN emulation is a technique of reproducing a LAN environment such as Ethernet based on asynchronous transfer mode (ATM)-type communication, and so on.

When LAN emulation is performed at a reconciliation sublayer (RS), a part of a preamble can be used as a PON tag. However, a multiplexing function is required because an OLT must operate as if it had n logical MAC entities corresponding to n ONUs in order to communicate with the n ONUs. Thus, a delay may vary due to multiplexing, and a bit error rate (BER) may be high due to additional buffering. However, the LAN emulation function performed at the upper layer of the MAC layer according to an exemplary embodiment does not require multiplexing. Thus, it is possible to provide a low BER, and simplify an 802.1D bridge by a single MAC.

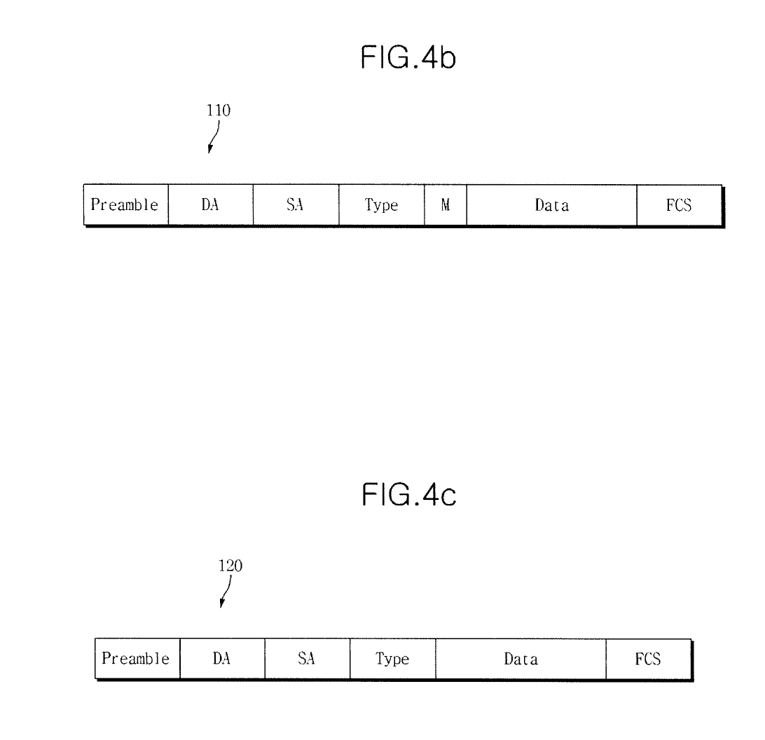

Referring to FIG. 3, the LAN emulation layer 12 receives a data frame from an ONU 30 or an external network 40. At this time, transmission type of the received data frame is identified based on a PON tag of the data frame transmitted from the OLT MAC layer 14 or a destination address (DA) of the data frame transmitted from the external network 40. The transmission type may be point-to-point (P2P), broadcast, or multicast. Also, according to the result of identifying the transmission type, an Ethernet frame 120, a frame 110 including only a mode bit, or a frame 100 including a PON tag is generated and transmitted to the ONU 30 or the external network 40. The constitutions of the generated frames will be described later with reference to FIGS. 4A to 4C.

The LAN emulation layer 12 according to an exemplary embodiment receives a data frame transmitted from the ONU 30 through the MAC layer 14, which is a lower layer. At this time, MAC header frame information (a DA and source address (SA)) collected by the MAC layer 14 is stored in an address mapping table of the OLT and used in the LAN emulation layer 12 according to necessity. And, a data frame generated in the LAN emulation layer 12 is transmitted to the ONU 30 through the MAC layer 14. Meanwhile, the LAN emulation layer 12 checks a mode bit and a logical link identifier (LLID) of a PON tag in a received data frame, and transmits a data frame generated according to the result of the check operation to the MAC layer 14.

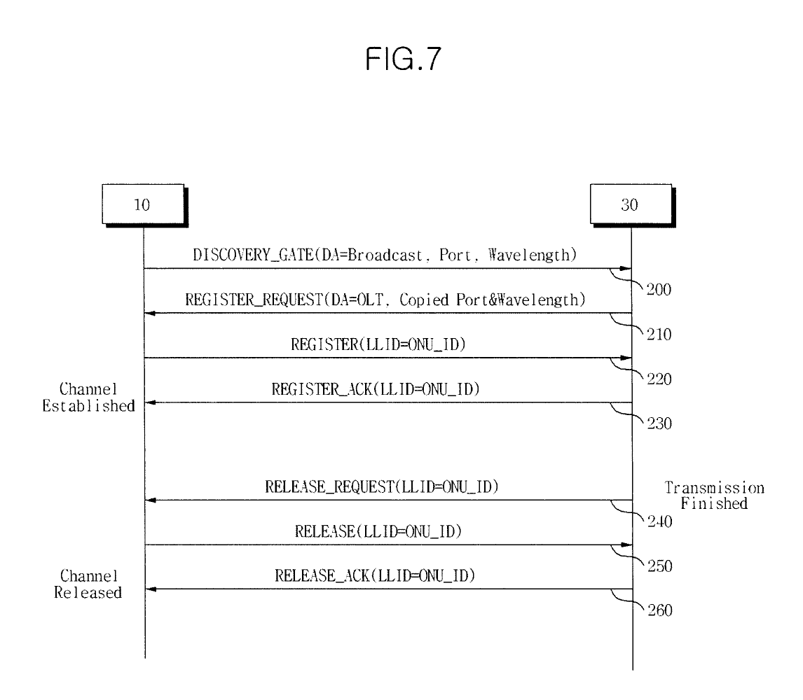

A LAN emulation process of the LAN emulation layer 12 according to an exemplary embodiment will be described in detail now. When registration of an ONU and LLID assignment are completed through a registration process that will be described later with reference to FIG. 7, an OLT performs the LAN emulation function based on a PON tag in a data transmission process. At this time, the ONU sets the mode bit of data to be transmitted to 0 or 1 and the LLID of the PON tag to the LLID of the transmission ONU, a multicast_group_ID, or a broadcast_ID, and transmits the frame to the OLT. The OLT receiving the frame transfers the PON tag and an Ethernet frame to the LAN emulation layer 12.

The LAN emulation layer 12 checks the mode bit and the LLID of the PON tag in the received frame. At this time, when the mode bit is 0 and the LLID is the LLID of the is transmission ONU, the frame transmitted from the ONU is a P2P frame. When the mode bit is 0 and the LLID is a broadcast_ID, the transmitted frame is a broadcast frame to be transmitted out of a PON. Also, when the mode bit is 1 and the LLID is a broadcast_ID, the transmitted frame is a broadcast frame to be transmitted in the PON. When the mode bit is 1 and the LLID is a multicast_group_ID, the transmitted frame is a multicast frame to be transmitted in the PON. Meanwhile, a frame transmitted from an external network is determined to be a P2P frame, broadcast frame, or multicast frame based on the DA field of the frame.

In a network architecture, different wavelengths are assigned to respective ONUs. Thus, P2P frames are transmitted with only a mode bit contained therein such that the ONUs can classify and process traffic. On the other hand, a PON tag is included in multicast frames and broadcast frames. In particular, in the case of a multicast frame, the LLID of a PON tag is a multicast_group_ID, and thus only ONUs belonging to the corresponding multicast service group receive the frame.

FIGS. 4A to 4C illustrate constitutions of data frames according to an exemplary embodiment. FIG. 4A illustrates a frame 100 including a PON tag 101, FIG. 4B illustrates a frame 110 including only a mode bit, and FIG. 4C illustrates an Ethernet frame 120 to be transmitted to an external network.

Referring to FIG. 4A, the data frame 100 including the PON tag 101 is transmitted and received between the MAC layer of an AWG-based WDM-PON and a LAN emulation layer, which is an upper layer of the MAC layer. Here, the data frame 100 including the PON tag includes a preamble, a DA field indicating a DA, a SA field indicating a SA, a type field indicating the type of the data frame 100, the PON tag 101, a data field containing actual data, and a frame check sequence (FCS) field containing information for detecting an error.

The PON tag 101 includes a mode bit M 102 for distinguishing between P2P and broadcast or multicast, and a LLID 103 indicating a logical link between an OLT and an ONU. The mode bit M 102 is used as a flag for distinguishing between P2P (M=0) and broadcast or multicast (M=1), and the LLID 103 is given while the ONU or a user is registered. Here, the frame 100 including a PON tag is a multicast or broadcast frame.

Referring to FIG. 4B, the frame 110 including only a mode bit M is the above-described frame 100 of FIG. 4A that includes a PON tag from which a LLID is removed, and is a P2P frame. Meanwhile, referring to FIG. 4C, the Ethernet frame 120 is the above-described frame 100 of FIG. 4A from which a PON tag is removed, and is a frame to be transmitted to an external network.

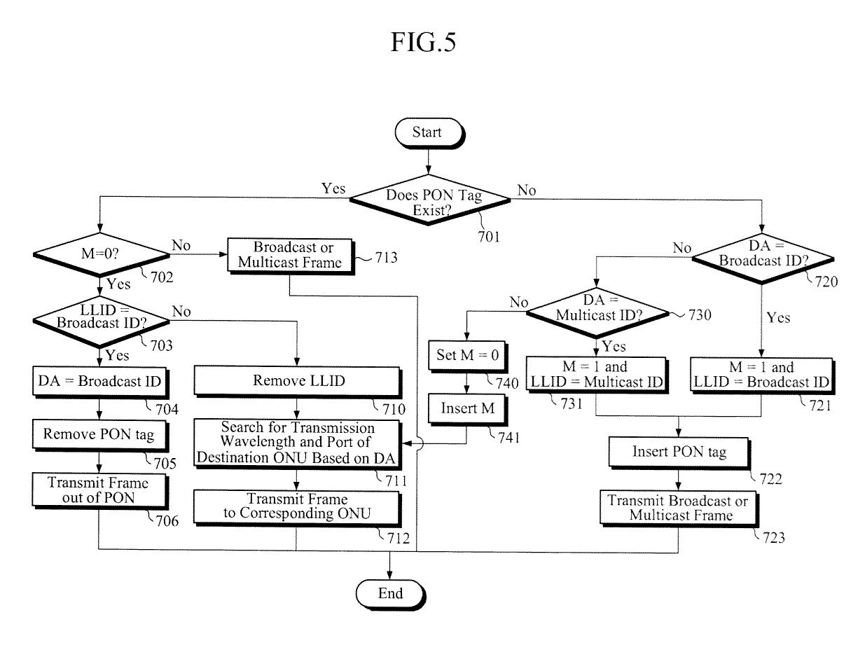

FIG. 5 is a flowchart illustrating a LAN emulation method of an OLT according to an exemplary embodiment.

The OLT according to an exemplary embodiment receives a data frame from an ONU or external network, and checks a PON tag of the data frame received from the ONU including a mode bit and a LLID or the DA of the data frame received from the external network, thereby identifying the transmission type of the received data frame. Here, when the data frame received from the ONU is a P2P frame, a data frame including only a mode bit is transmitted to the ONU. When the data frame received from the ONU is a broadcast frame, a data frame is transmitted to the external network with a PON tag removed, or transmitted into a PON without change. Also, when the data frame received from the external network is a multicast or broadcast frame, a data frame into which a PON tag is inserted is transmitted to the ONU, and when the data frame received from the external network is a P2P frame, a data frame into which a mode bit is inserted is transmitted to the ONU.

A data frame processing process of an OLT according to an exemplary embodiment will be described in detail now with reference to FIG. 5. First, when a new data frame is received, the OLT checks whether a PON tag is included in the data frame (701). A frame transmitted is from an ONU has a PON tag, but a frame transmitted from an external network is an Ethernet frame having no PON tag. Here, when a PON tag is included, it is checked whether a mode bit M is 0 (702). When it is found that the mode bit M is 0, a LLID is checked (703). When the LLID is a broadcast_ID, a DA is set to the broadcast_ID (704). Then, the PON tag is removed (705), and the frame is transmitted out of a PON (706).

Meanwhile, when it is found in operation 703 that the LLID is an ONU_ID, the LLID is removed (710). Then, port information and wavelength information of a destination ONU are searched for based on the DA of the frame (711), and the data frame is transmitted to the ONU (712). Also, when it is found in operation 702 that the mode bit M is 1, the frame is transmitted to ONUs without change by broadcasting or multicasting (713).

When it is found in operation 701 that no PON tag is included, the received frame is processed based on the DA field. The DA of the received framed is checked (720). When the DA of the received frame is broadcast, the mode bit M is set to 1, and the LLID is set to a broadcast_ID (721). Subsequently, a PON tag is inserted (722), and the frame is broadcast or multicast to all ONUs (723).

Meanwhile, when it is found in operation 720 that the DA of the received frame is not a broadcast_ID, it is checked whether the DA of the received frame is a multicast_ID (730). When the DA of the received frame is a multicast_ID, the mode bit M is set to 1, and the LLID is set to a multicast_ID (731). Subsequently, a PON tag is inserted (722), and the frame is broadcast or multicast to all ONUs (723). On the other hand, when it is found in operation 730 that the DA of the received frame is an ONU MAC address, the mode bit M is set to 0 (740) and inserted into the data frame (741). Subsequently, port information and wavelength information of the corresponding ONU are searched for based on the DA of the data frame (711), and the data frame is transmitted to the ONU (712).

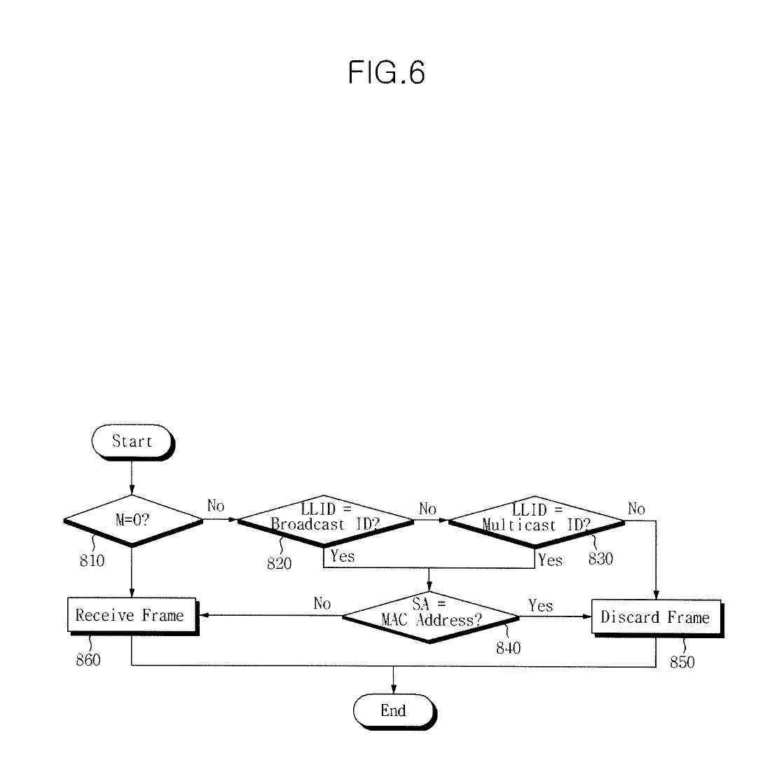

FIG. 6 is a flowchart illustrating a data frame receiving method of an ONU according to an exemplary embodiment.

When a new data frame arrives, the ONU according to an exemplary embodiment checks a mode bit M and a LLID of the data frame. When the mode bit M is 0, or when the mode bit M is 1 and a SA is not the MAC address of the ONU, the ONU receives a new data frame.

A data frame processing process of an ONU according to an exemplary embodiment will be described in detail now with reference to FIG. 6. A SA field is used such that multicast and broadcast frames are not transferred to a transmission ONU (source) for shared LAN emulation of Ethernet. First, the ONU checks whether the mode bit M is 0 (810). When a mode bit M is 0, the corresponding frame relates to a P2P service, and thus the ONU receives the frame.

On the other hand, when the mode bit M is 1, the ONU checks whether a LLID is a broadcast_ID (820). When it is found that the LLID is a broadcast_ID, a SA is checked. When the SA is the same as the MAC address of the ONU, the frame is discarded (850), and when the SA is not the same as the MAC address of the ONU, the frame is received (860). When the LLID is not a broadcast_ID, the ONU checks whether the LLID is a multicast_ID (830). When it is found that the LLID is not a multicast_ID, a frame is discarded (850). Otherwise, the SA field is checked (840). When a value of the SA field is the same as the MAC address of the ONU, the ONU discards the frame (850), and when the value is not the same as the MAC address of the ONU, the ONU receives the frame (860).

FIG. 7 is a signal flow diagram illustrating a process of assigning a LLID according to an exemplary embodiment.

Referring to FIG. 7, in order to assign a LLID, a WDM-PON OLT according to an exemplary embodiment broadcasts a discovery message DISCOVERY_GATE 200 including port information and transmission wavelength information to an ONU, and receives a registration request message REGISTER_REQUEST 210 including port information, wavelength information and SA information of the ONU from the ONU receiving the discovery message DISCOVERY_GATE 200. Subsequently, the OLT transmits a registration message REGISTER 220 that assigns a LLID to the ONU according to the received registration request message REGISTER_REQUEST 210 to the ONU, and receives a registration response message REGISTER_ACK 230 including the assigned LLID from the ONU receiving the registration message REGISTER 220.

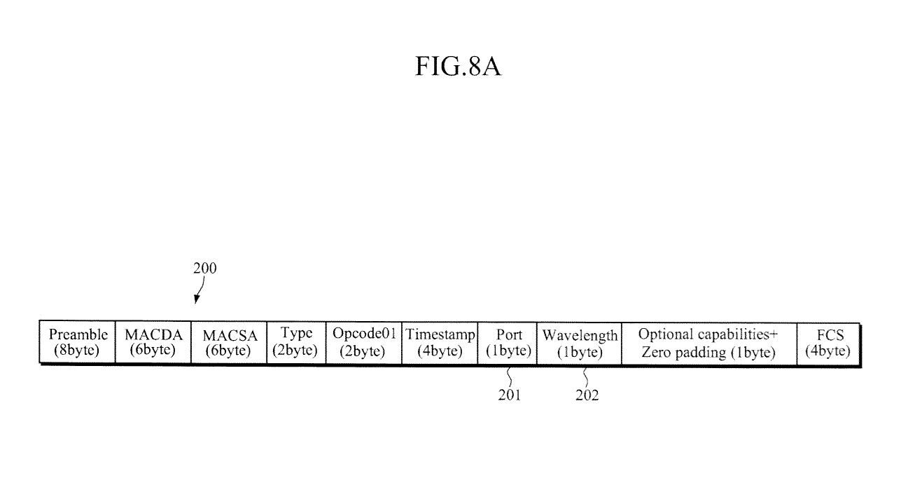

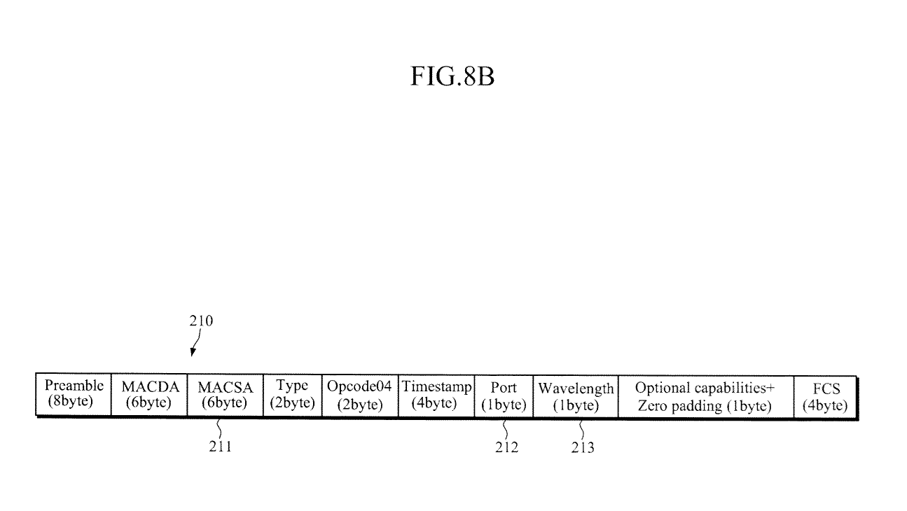

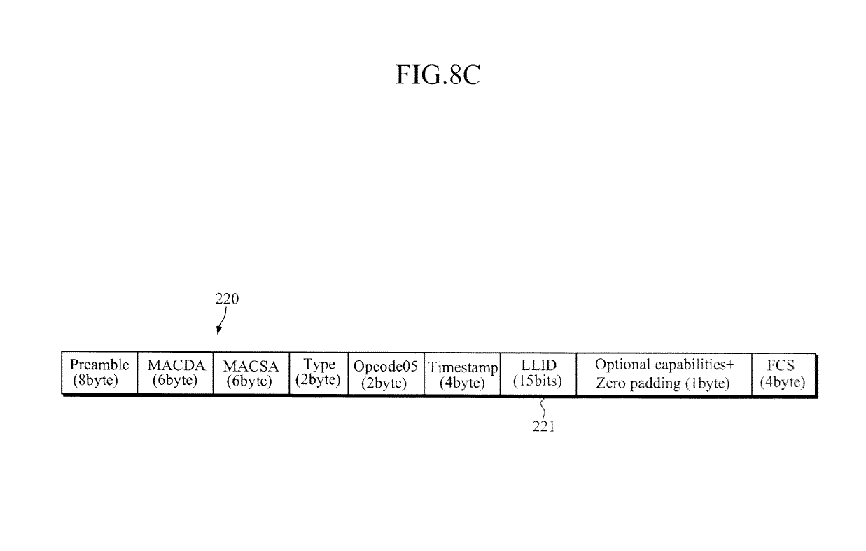

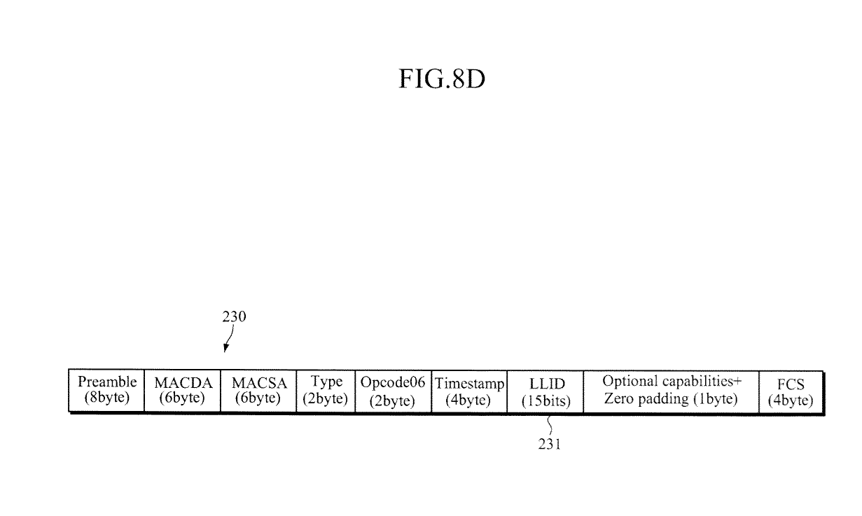

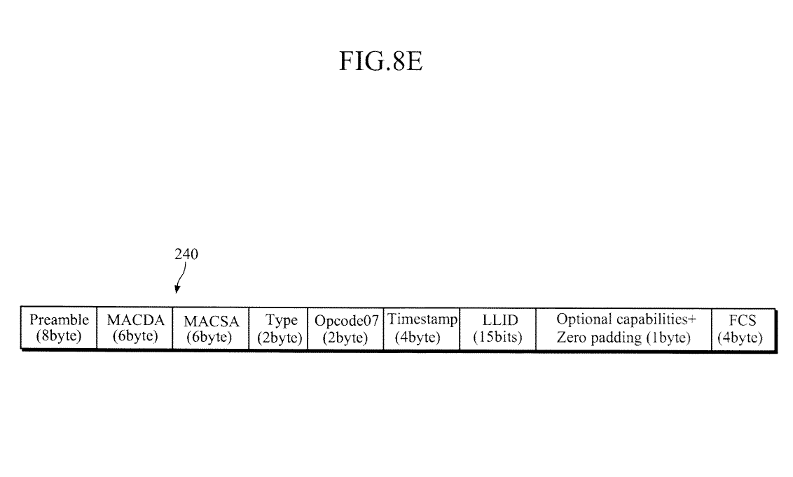

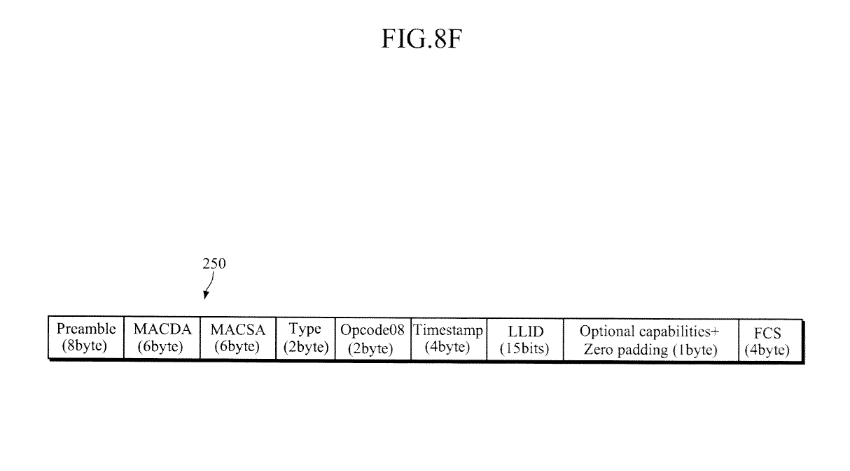

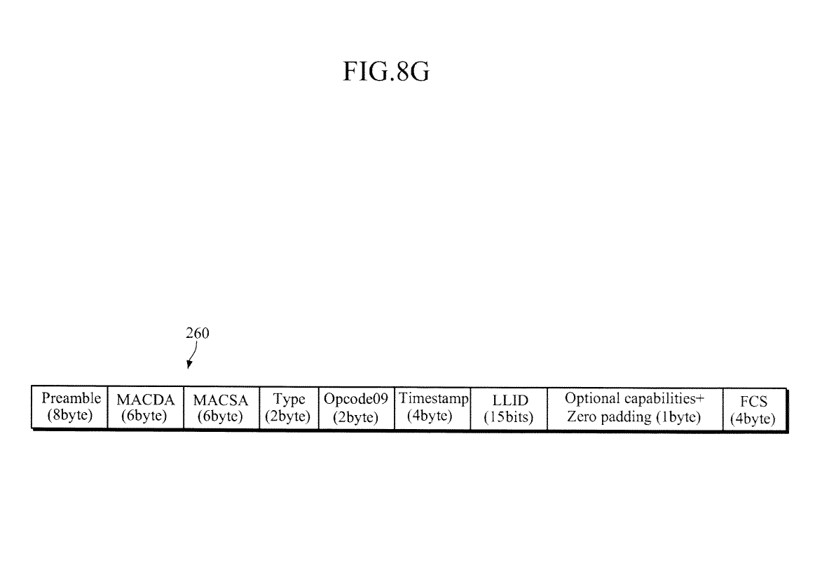

A LLID assignment process of an OLT according to an exemplary embodiment will be described in detail now with reference to FIG. 7. To register ONUs and assign LLIDs, an OLT performs the following process using control messages that will be described later with reference to FIG. 8. First, the OLT transmits the discovery message 200 to all ONUs. Since the downlink transmission wavelength of each ONU included in a WDM-PON is determined according to a connection port between the OLT and an RN and an input wavelength, the OLT must have information about a transmission port and wavelength corresponding to the ONU. Thus, the OLT records port information and transmission wavelength information in a port field 201 and a wavelength field 202 of the discovery message 200, and transmits the discovery message 200 to the ONUs.

Each ONU receiving the discovery message 200 records its own MAC address in a SA field 211 of the registration request message 210, records port and wavelength information obtained from the discovery message 200 in a port field 212 and a wavelength field 213, and transmits the registration request message 210 to the OLT.

The OLT receiving the registration request message 210 from the ONU assigns a LLID and manages the assigned LLID, the MAC address, and the port and wavelength information using a table. The OLT records the assigned LLID in a LLID field 221 of the registration message 220 and transmits the registration message 220 to the ONU. In response to the received registration message 220, the ONU records the assigned LLID in a LLID field 231 of the registration response message 230 and transmits the registration response message 230 to the OLT.

The LLID assignment process may additionally include an operation of releasing the registration and the LLID after the transmission is completed. To be specific, after the transmission is completed, the ONU transmits a registration release request message RELEASE_REQUEST 240 to the OLT in order to release the registration and the LLID. The OLT receiving the registration release request message 240 transmits a registration release message RELEASE 250 to the ONU. When the OLT receives a registration release response message RELEASE_ACK 260 from the ONU, it removes the LLID and all information of the ONU from the table.

FIGS. 8A to 8G illustrate constitutions of control messages of FIG. 7 for assigning a LLID.

Referring to FIGS. 8A to 8G, the discovery message DISCOVERY_GATE 200, the registration request message REGISTER_REQUEST 210, the registration message REGISTER 220, and the registration response message REGISTER_ACK 230 are used for ONU registration and LLID assignment, and the registration release request message RELEASE_REQUEST 240, the registration release message RELEASE 250, and the registration release response message RELEASE_ACK 260 are used for LLID release. These control messages use a modified data field of a 64-byte Ethernet frame, and have a preamble field (8 bytes), a DA field (6 bytes), a SA field (6 bytes), a type field (2 bytes), an operation code (OPcode) field (2 bytes), a timestamp field (4 bytes), and a FSC field (4 bytes) in common. Control messages are distinguished from data messages by the OPcode field.

The present invention can be implemented as computer readable codes in a computer readable record medium. The computer readable record medium includes all types of record media in which computer readable data are stored. Examples of the computer readable record medium include a ROM, a RAM, a CD-ROM, a magnetic tape, a floppy disk, and an optical data storage. Further, the record medium may be implemented in the form of a carrier wave such as Internet transmission. In addition, the computer readable record medium may be distributed to computer systems over a network, in which computer readable codes may be stored and executed in a distributed manner.

As apparent from the above description, an exemplary embodiment can provide a LAN emulation function of a WDM-PON. In particular, in an AWG-based WDM-PON, the LAN emulation function can be provided using a mode bit and LLID regardless of the number of AWGs constituting a RN, the number of input ports of the AWGs, or the number of wavelengths.

It will be apparent to those of ordinary skill in the art that various modifications can be made to the exemplary embodiments of the invention described above. However, as long as modifications fall within the scope of the appended claims and their equivalents, they should not be misconstrued as a departure from the scope of the invention itself.

What is claimed is:

1. A local area network (LAN) emulation method of an optical line terminal (OLT) for a wavelength division multiplexing (WDM)-passive optical network (PON), the method comprising:
receiving a data frame from an optical network unit (ONU) or an external network;
checking a PON tag of the data frame received from the ONU including a mode bit and a logical link identifier (LLID) or a destination address (DA) of the data frame received from the external network, and identifying a transmission type of the received data frame; and
generating a new data frame based on the result of the identification operation, and transmitting the new data frame to the ONU or the external network.

2. The LAN emulation method of claim 1, wherein the operations are performed at a LAN emulation layer that is an upper layer of a media access control (MAC) layer of the OLT.

3. The LAN emulation method of claim 1, wherein the identifying of the transmission type of the received data frame includes, when the received data frame does not have the PON tag, identifying the received data frame as a multicast frame or a broadcast frame transmitted from the external network.

4. The LAN emulation method of claim 1, wherein the identifying of the transmission type of the received data frame includes identifying the received data frame as a broadcast frame or a point-to-point (P2P) frame transmitted from the ONU according to the LLID of the received data frame.

5. The LAN emulation method of claim 1, wherein the transmitting of the new data frame to the ONU or the external network includes, when the data frame received from the ONU is a point-to-point (P2P) frame, transmitting the data frame to the ONU with the LLID removed, and
when the data frame received from the ONU is a broadcast frame, transmitting the data frame to the external network with the PON tag removed or to the ONU in a PON without changing the PON tag.

6. The LAN emulation method of claim 1, wherein the transmitting of the new data frame to the ONU or the external network includes, when the data frame received from the external network is a multicast frame or a broadcast frame, transmitting the data frame to the ONU with a PON tag inserted therein, and
when the data frame received from the external network is a point-to-point (P2P) frame, transmitting the data frame to the ONU with a mode bit inserted therein.

7. The LAN emulation method of claim 1, wherein the WDM-PON includes a remote node (RN) in the form of an arrayed-waveguide grating (AWG).

8. A data frame receiving method of an optical network unit (ONU) for a wavelength division multiplexing (WDM)-passive optical network (PON), the method comprising:
when a new data frame arrives, checking a mode bit and a logical link identifier (LLID) of the data frame;
when it is found that the mode bit is 0, receiving the new data frame; and
when it is found that the mode bit is 1 and a source address (SA) is not a media access control (MAC) address of the ONU, receiving the new data frame.

9. The data frame receiving method of claim 8, further comprising, when the mode bit of the new data frame is 1, identifying whether the new data frame is a broadcast frame or a multicast frame based on the LLID.

10. A logical link identifier (LLID) assignment method of an optical line terminal (OLT) for a wavelength division multiplexing (WDM)-passive optical network (PON), the method comprising:
broadcasting a discovery message including port information and transmission wavelength information to optical network units (ONUs);
receiving a registration request message including the port information, the transmission wavelength information and source address (SA) information of the ONU from an ONU receiving the discovery message;
transmitting a registration message assigning a LLID to the ONU according to the is received registration request message to the ONU; and
receiving a registration response message including the assigned LLID from the ONU receiving the registration message.

11. The LLID assignment method of claim 10, further comprising:
receiving a registration release request message from the ONU;
transmitting a registration release message to the ONU in response to the received registration release request message; and
receiving a registration release response message from the ONU receiving the registration release message.

12. An information storage medium storing a local area network (LAN) emulation layer data structure of an optical line terminal (OLT) for a wavelength division multiplexing (WDM)-passive optical network (PON), the medium comprising:
a media access control (MAC) layer that is a lower layer receiving a data frame transmitted from an optical network unit (ONU), removing a MAC frame header, transmitting a PON tag and data to a shared LAN emulation layer that is an upper layer, receiving a data frame generated from the shared LAN emulation layer, and transmitting the data frame to the ONU; and
the shared LAN emulation layer checking a mode bit and a logical link identifier (LLID) of the data frame received through the MAC layer, and transmitting the data frame generated according to the result of the check operation to the MAC layer.

13. An information storage medium storing a structure of a data frame transmitted between a media access control (MAC) layer of an optical line terminal (OLT) for a wavelength division multiplexing (WDM)-passive optical network (PON) and a local area network (LAN) emulation layer that is an upper layer of the MAC layer, the medium comprising:
a preamble;
a destination address (DA) field indicating a DA;
a source address (SA) field indicating a SA;
a type field indicating a type of the data frame;
a PON tag including a mode bit for distinguishing between point-to-point (P2P) and broadcast or multicast, and a logical link identifier (LLID) indicating a logical link between the OLT and an optical network unit (ONU);
a data field containing data; and
a frame check sequence (FCS) field containing information for detecting an error.
